(19) United States
(12) Patent Application Publication
(10) Pub. No.: US 2015/0248716 A1
(43) Pub. Date: Sep. 3, 2015

(54) COLLABORATIVE JEWELRY BUILDER

(71) Applicant: COMENITY LLC, Columbus, OH (US)

(72) Inventors: Richard Barber AINSWORTH, III, Dublin, OH (US); Adam KOLTNOW, Worthington, OH (US)

(73) Assignee: COMENITY LLC, Columbus, OH (US)

(21) Appl. No.: 14/634,443

(22) Filed: Feb. 27, 2015

Related U.S. Application Data
(60) Provisional application No. 61/947,308, filed on Mar. 3, 2014.

(51) Int. Cl. G06Q 30/06; G06Q 50/00; A44C 27/00

(52) U.S. Cl. CPC G06Q 30/0621; A44C 27/00; G06Q 50/01

(57) ABSTRACT

A collaborative jewelry building method is described. The method accesses a jewelry designing application from an Internet capable device. The jewelry designing application is utilized to design a virtual piece of jewelry. The virtual piece of jewelry is then exposed to a user's social media group for feedback. The feedback about the virtual piece of jewelry from the user's social media group is utilized to finalize a design of the virtual piece of jewelry. After the design is finalized, a jeweler is commissioned, via the jewelry designing application, to build an actual piece of jewelry based on the design of the virtual piece of jewelry.

### CROSS-REFERENCE TO RELATED APPLICATIONS

This application claims priority to and benefit of co-pending U.S. Patent Application No. 61/947,308, filed on Mar. 3, 2014 entitled “COLLABORATIVE JEWELRY BUILDER” by Richard Barber Ainsworth, III, having Attorney Docket No. ADS-050.PRO, and assigned to the assignee of the present application.

### BACKGROUND

Most jewelry shops sell premade jewelry. The premade jewelry is designed by a jewelry designer, manufactured off site and then displayed in the stores display case or on the stores' web site. Normally, when a customer wishes to purchase an item of jewelry, the customer will peruse the available options, select the desired piece for purchase.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description should not be understood as being drawn to scale unless specifically noted.

FIG. 1 is a block diagram of a collaborative jewelry building system, in accordance with an embodiment.

FIG. 2 depicts a flow diagram for a method for collaborative jewelry building, in accordance with an embodiment.

FIG. 3 is a block diagram of an example computer system with which or upon which various embodiments of the present invention may be implemented.

### DESCRIPTION OF EMBODIMENTS

Reference will now be made in detail to embodiments of the subject matter, examples of which are illustrated in the accompanying drawings. While the subject matter discussed herein will be described in conjunction with various embodiments, it will be understood that they are not intended to limit the subject matter to these embodiments. On the contrary, the presented embodiments are intended to cover alternatives, modifications and equivalents, which may be included within the spirit and scope of the various embodiments as defined by the appended claims. Furthermore, in the Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Unless specifically stated otherwise as apparent from the following discussions, it is appreciated that throughout the present Description of Embodiments, discussions utilizing terms such as “ exposing”, “selecting”, “outputting”, “inputting”, “providing”, “receiving”, “utilizing”, “obtaining”, “commissioning”, “accessing” or the like, often refer to the actions and processes of an electronic computing device/system, such as a desktop computer, notebook computer, tablet, mobile phone, and electronic personal display, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

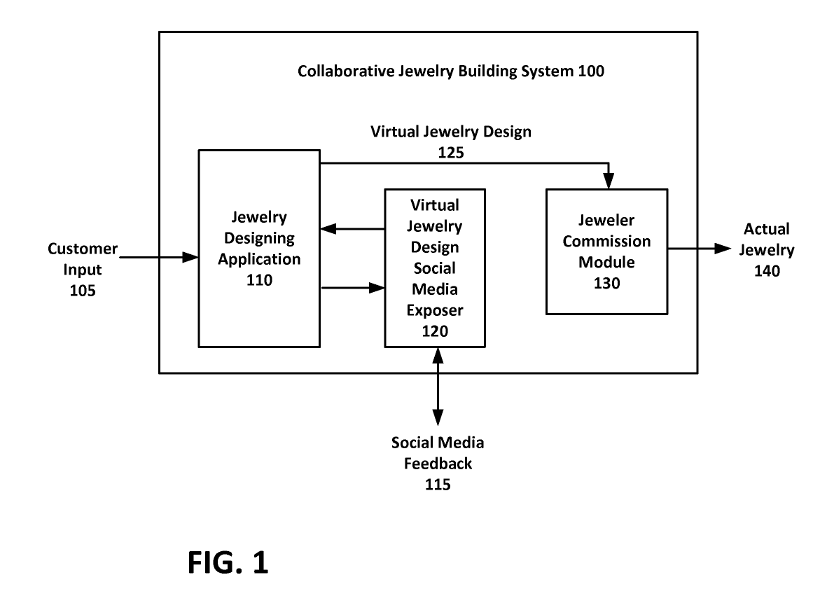

FIG. 1 is a block diagram of a collaborative jewelry building system 100, in accordance with an embodiment. In one embodiment, the jewelry building system 100 is a configurator application that enables a user to custom build jewelry. In one embodiment, a budget can be set and the configurator provides options that keep the total cost of the jewelry within a budget range. For example, a user can select a setting, diamond, and design to build a custom engagement ring. In one embodiment, once the design is finalized, users can share the proposed design with friend and family via social media to get input. In one embodiment, the collaborative jewelry building system 100 enables another to purchase the jewelry for the person that designed it.

In general, collaborative jewelry building system 100 receives customer input 105 which is used to develop a virtual jewelry design 125. After the customer is satisfied with the virtual jewelry design, collaborative jewelry building system 100 commissions a jeweler to build an actual piece of jewelry 140.

Collaborative jewelry building system 100 includes a jewelry designing application 110, a virtual jewelry design social media exposer 120, and a jeweler commission module 130.

In general, jewelry designing application 110 is an application that can be used on a number of different platforms to design a virtual piece of jewelry. In one embodiment, jewelry designing application 110 may be downloaded from an app store to a user's personal device. In another embodiment, jewelry designing application 110 may be provided at a jewelry store's website and the customer must log in to utilize jewelry designing application 110. In another embodiment, the user may have to purchase jewelry designing application 110. Further, the user could receive a refund for the purchase price of jewelry designing application 110 when an order for a customer designed piece of jewelry is placed.

In one embodiment, jewelry designing application 110 receives customer input 105 with a goal of having the user design their own piece of jewelry to be ultimately purchased and built. However, collaborative jewelry building system 100 additionally provides virtual jewelry design social media exposer 120 which exposes the virtual piece of jewelry designed by the customer to the customer's social media group. In one embodiment, the customer may select the members of the social media group that can provide social media feedback 115 about the design. In another embodiment, the customer may allow anyone connected with them via any channel of social media to provide input and social media feedback 115 about the virtual jewelry design.

Once the social media feedback 115 is received, virtual jewelry design social media exposer 120 provides the feedback to jewelry designing application 110 where the feedback is exposed to the customer. At that time, the customer input 105 can start to modify the virtual jewelry design by accepting social media feedback 15 comments and changes. For example, the customer may accept all of the suggested changes, accept some changes, accept no changes, accept changes from some friends but not from other friends, and the like. For example, if the customer is designing a wedding ring, the changes suggested from husbands, fathers, mothers and Bridesmaids may be weighed a little more heavily due to their event specific involvement. Although it is only described as happening once, the process of tweaking and social media exposure may be very iterative such that they occur numerous times until the customer is satisfied.

When the customer is satisfied with the virtual jewelry design 125, collaborative jewelry building system 100 commissions a jeweler to build an actual piece of jewelry 140 from the virtual jewelry design 125.

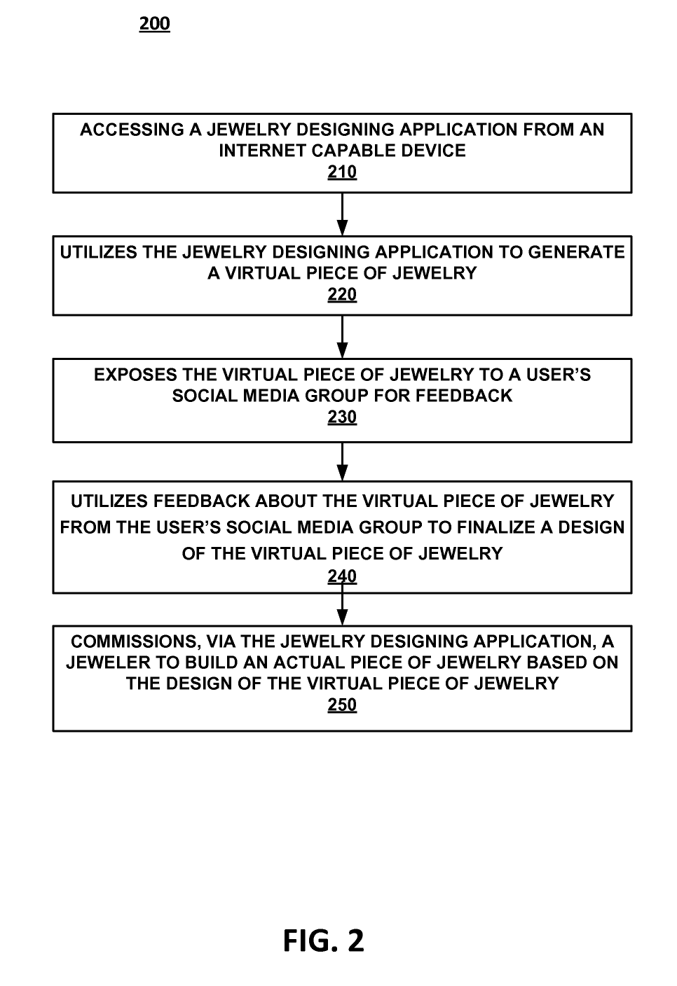

FIG. 2 depicts a flow diagram for a collaborative jewelry building method, in accordance with an embodiment.

With reference now to 210 of FIG. 2, one embodiment accesses a jewelry designing application from an Internet capable device. For example, a customer may access the jewelry designing application from an internet accessing device such as, but not limited to, a desktop computer, laptop computer, notebook computer, tablet, mobile handheld device, mobile phone, GUI, wearable Internet accessible device, and the like. Moreover, the customer may purchase or download the jewelry designing application 110 onto their personal computing device.

Referring now to 220 of FIG. 2, one embodiment utilizes the jewelry designing application 110 to generate a virtual piece of jewelry. In one embodiment, jewelry designing application 110 provides a number of user levels and options. For example, when designing a ring, jewelry designing application 110 may be as high or low of a level as desired. For example, in a high level design situation, the customer input 105 may be as simple as selecting a metal type for the band, a center stone and a mounting. Conversely, in a low level design scenario, the customer may wish to design the shank around the ring, the shape, type or number of prongs on the mounting, and the like.

With reference now to 230 of FIG. 2, one embodiment exposes the virtual piece of jewelry to a user's social media group for feedback. Once the customer has completed the virtual jewelry design, in this case a ring, but the jewelry may be a necklace, pin, broach, tie clip, bracelet, hair comb, and the like. The virtual jewelry design social media exposer 120 provides the virtual jewelry design 125 to the customer's social media group for feedback, comments and evaluation. Virtual jewelry design social media exposer 120 also receives the social media feedback 115 and provides the feedback to the jewelry designing application 110.

For example, the social media feedback 115 may point out that the mounting may be too high and could snag on clothing. Another social media feedback 115 may point out that the ring looks like someone else's. Additional social media feedback 115 may include positive comments, small tweaks or suggestions, and the like. In one embodiment, virtual jewelry design social media exposer 120 may also have a filter setting to keep unwanted, unhelpful or rude comments from being displayed to the customer designing the jewelry.

Referring now to 240 of FIG. 2, one embodiment utilizes the feedback 115 about the virtual piece of jewelry from the user's social media group to finalize a design of the virtual piece of jewelry. For example, if the comment about the mounting seems viable, customer input 105 may be used to modify the height or shape of the mounting. As stated herein, the social media feedback 115 loop may be performed on more than one occasion. Once the virtual jewelry design 125 is acceptable to the customer, the customer input 105 authorizes jewelry designing application 110 to pass the virtual jewelry design 125 to jeweler commission module 130.

With reference now to 250 of FIG. 2, one embodiment commissions, via the jeweler commission module 130, a jeweler to build an actual piece of jewelry based on the design of the virtual piece of jewelry. At that time, the customer receives a time frame for the build and when the actual jewelry 140 will be available for pick-up. In one embodiment, a deposit may be required before the commissioning of the piece is commenced. In another embodiment, payment in full may be required prior to the building of the piece of actual jewelry 140.

### Example Computer System Environment

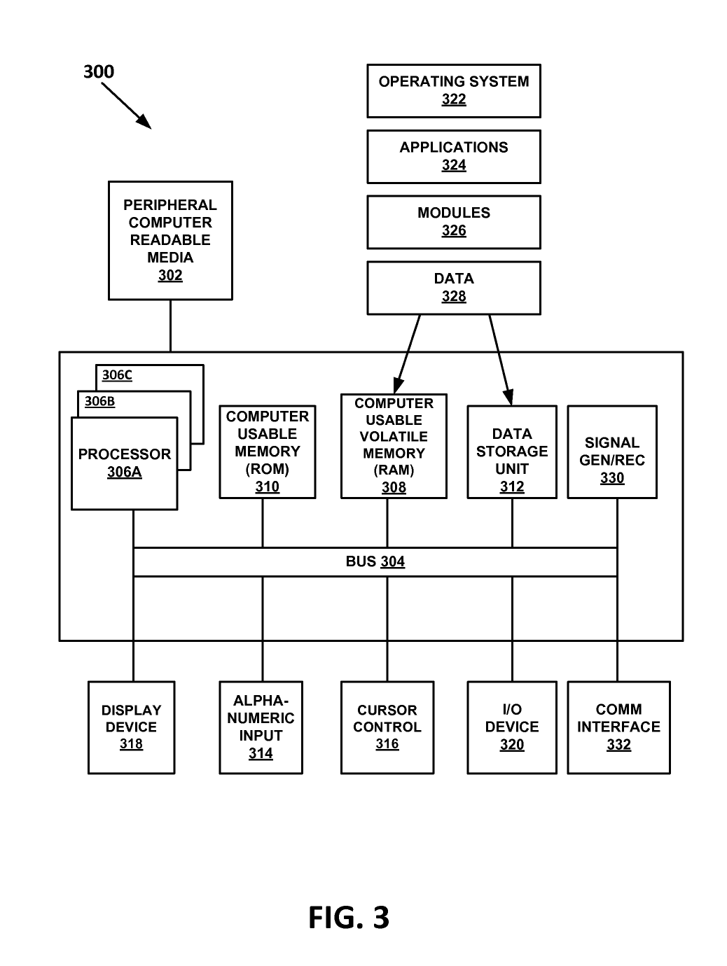

With reference now to FIG. 3, portions of the technology for providing a communication composed of computer-readable and computer-executable instructions that reside, for example, in non-transitory computer-usable storage media of a computer system. That is, FIG. 3 illustrates one example of a type of computer that can be used to implement embodiments of the present technology. FIG. 3 represents a system or components that may be used in conjunction with aspects of the present technology. In one embodiment, some or all of the components described herein may be combined with some or all of the components of FIG. 3 to practice the present technology.

FIG. 3 illustrates an example computer system 300 used in accordance with embodiments of the present technology. It is appreciated that system 300 of FIG. 3 is an example only and that the present technology can operate on or within a number of different computer systems including general purpose networked computer systems, embedded computer systems, routers, switches, server devices, user devices, various intermediate devices/artifacts, stand-alone computer systems, mobile phones, personal data assistants, televisions and the like. As shown in FIG. 3, computer system 300 of FIG. 3 is well adapted to having peripheral computer readable media 302 such as, for example, a floppy disk, a compact disc, a flash drive, and the like coupled thereto.

Computer system 300 of FIG. 3 includes an address/data/control bus 304 for communicating information, and a processor 306A coupled to bus 304 for processing information and instructions. As depicted in FIG. 3, system 300 is also well suited to a multi-processor environment in which a plurality of processors 306A, 306B, and 306C are present. Conversely, system 300 is also well suited to having a single processor such as, for example, processor 306A. Processors 306A, 306B, and 306C may be any of various types of microprocessors. Computer system 300 also includes data storage features such as a computer usable volatile memory 308, e.g., random access memory (RAM), coupled to bus 304 for storing information and instructions for processors 306A, 306B, and 306C.

System 300 also includes computer usable non-volatile memory 310, e.g., read only memory (ROM), coupled to bus 304 for storing static information and instructions for processors 306A, 306B, and 306C. Also present in system 300 is a data storage unit 312 (e.g., a magnetic or optical disk and disk drive) coupled to bus 304 for storing information and instructions. Computer system 300 also includes an optional alpha-numeric input device 314 including alphanumeric and function keys coupled to bus 304 for communicating information and command selections to processor 306A or processors 306A, 306B, and 306C. Computer system 300 also includes an optional cursor control device 316 coupled to bus 304 for communicating user input information and command selections to processor 306A or processors 306A, 306B, and 306C. Optional cursor control device may be a touch sensor, gesture recognition device, and the like. Computer system 300 of the present embodiment also includes an optional display device 318 coupled to bus 304 for displaying information.

Referring still to FIG. 3, optional display device 318 of FIG. 3 may be a liquid crystal device, cathode ray tube, OLED, plasma display device or other display device suitable for creating graphic images and alpha-numeric characters recognizable to a user. Optional cursor control device 316 allows the computer user to dynamically signal the movement of a visible symbol (cursor) on a display screen of display device 318. Many implementations of cursor control device 316 are known in the art including a trackball, mouse, touch pad, joystick or special keys on alpha-numeric input device 314 capable of signaling movement of a given direction or manner of displacement. Alternatively, it will be appreciated that a cursor can be directed and/or activated via input from alpha-numeric input device 314 using special keys and key sequence commands.

System 300 is also well suited to having a cursor directed by other means such as, for example, voice commands. Computer system 300 also includes an I/O device 320 for coupling system 300 with external entities. For example, in one embodiment, I/O device 320 is a modem for enabling wired or wireless communications between system 300 and an external network such as, but not limited to, the Internet or intranet. A more detailed discussion of the present technology is found below.

Referring still to FIG. 3, various other components are depicted for system 300. Specifically, when present, an operating system 322, applications 324, modules 326, and data 328 are shown as typically residing in one or some combination of computer usable volatile memory 308, e.g. random access memory (RAM), and data storage unit 312. However, it is appreciated that in some embodiments, operating system 322 may be stored in other locations such as on a network or on a flash drive; and that further, operating system 322 may be accessed from a remote location via, for example, a coupling to the internet. In one embodiment, the present technology, for example, is stored as an application 324 or module 326 in memory locations within RAM 308 and memory areas within data storage unit 312. The present technology may be applied to one or more elements of described system 300.

System 300 also includes one or more signal generating and receiving device(s) 330 coupled with bus 304 for enabling system 300 to interface with other electronic devices and computer systems. Signal generating and receiving device(s) 330 of the present embodiment may include wired serial adaptors, modems, and network adaptors, wireless modems, and wireless network adaptors, and other such communication technology. The signal generating and receiving device(s) 330 may work in conjunction with one or more communication interface(s) 332 for coupling information to and/or from system 300. Communication interface 332 may include a serial port, parallel port, Universal Serial Bus (USB), Ethernet port, Bluetooth, thunderbolt, near field communications port, WiFi, Cellular modem, or other input/output interface. Communication interface 332 may physically, electrically, optically, or wirelessly (e.g., via radio frequency) couple system 300 with another device, such as a cellular telephone, radio, or computer system.

The computing system 300 is only one example of a suitable computing environment and is not intended to suggest any limitation as to the scope of use or functionality of the present technology. Neither should the computing environment 300 be interpreted as having any dependency or requirement relating to any one or combination of components illustrated in the example computing system 300.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A collaborative jewelry building method comprising:
accessing a jewelry designing application from an Internet capable device;
utilizing the jewelry designing application to generate a virtual piece of jewelry;
exposing the virtual piece of jewelry to a user's social media group for feedback;
utilizing feedback about the virtual piece of jewelry from the user's social media group to finalize a design of the virtual piece of jewelry; and
commissioning, via the jewelry designing application, a jeweler to build an actual piece of jewelry based on the design of the virtual piece of jewelry.

2. The method of claim 1 further comprising:
providing payment via the jewelry designing application for the actual piece of jewelry.

3. The method of claim 1 further comprising:
establishing a budget for said virtual piece of jewelry utilizing the jewelry designing application.

4. The method of claim 1 wherein the jewelry designing application is a downloadable application configured to be used on a smart phone device.

5. The method of claim 1 further comprising:
selecting a setting for an engagement ring utilizing the jewelry designing application.

6. The method of claim 5 further comprising:
selecting a diamond size for the setting of the engagement ring utilizing the jewelry designing application.

7. The method of claim 6 further comprising:
selecting a diamond cut of said engagement ring utilizing the jewelry designing application.

8. A collaborative jewelry building method comprising:
providing a jewelry designing application accessible from an Internet capable device;
generating a virtual piece of jewelry based on user input received at the jewelry designing application;
enabling the virtual piece of jewelry to be shared on a user's social media group for feedback;
finalizing a design of the virtual piece of jewelry based on the feedback; and
assigning a jeweler to build an actual piece of jewelry based on the design of the virtual piece of jewelry.

9. The method of claim 8 further comprising:
processing a payment via the jewelry designing application for the actual piece of jewelry.

10. The method of claim 9 further comprising:
issuing a line of credit for said payment for the actual piece of jewelry.

11. The method of claim 8 further comprising:
receiving a budget for said virtual piece of jewelry utilizing the jewelry designing application.

12. The method of claim 8 wherein the jewelry designing application is a downloadable application configured to be used on a smart phone device.

13. The method of claim 8 further comprising:
receiving input for selecting a setting for an engagement ring utilizing the jewelry designing application.

14. The method of claim 13 further comprising:
receiving input for selecting a diamond size for the setting of the engagement ring utilizing the jewelry designing application.

15. The method of claim 14 further comprising:
receiving input for selecting a diamond cut of said engagement ring utilizing the jewelry designing application.

16. A collaborative jewelry building application comprising:
a jewelry designing interface accessible from an Internet capable device and configured for receiving user input;
a jewelry design engine for generating a virtual piece of jewelry based on user input received at the jewelry designing application;
a design sharing platform for enabling the virtual piece of jewelry to be shared on a user's social media group for feedback; and
a job scheduler for assigning a jeweler to build an actual piece of jewelry based on the design of the virtual piece of jewelry.

17. The collaborative jewelry building application of claim 16 further comprising:
a payment processor for processing a payment via the jewelry designing application for the actual piece of jewelry.

18. The collaborative jewelry building application of claim 17 further comprising:
a credit source for issuing a line of credit for said payment for the actual piece of jewelry.

19. The collaborative jewelry building application of claim 17 wherein said a jewelry designing interface is configured for receiving a budget for said virtual piece of jewelry.

20. The collaborative jewelry building application of claim 17 wherein the jewelry designing application comprises a downloadable portion configured to be used on a smart phone device.

21. The collaborative jewelry building application of claim 17 wherein said jewelry designing interface is configured for receiving input for selecting a setting for an engagement ring.

22. The collaborative jewelry building application of claim 21 wherein said jewelry design interface is further configured for receiving input for selecting a diamond size for the setting of the engagement ring.

23. The collaborative jewelry building application of claim 22 wherein said jewelry design interface is further configured for receiving input for selecting a diamond cut of said engagement ring.
